(19) United States
(12) Patent Application Publication
(10) Pub. No.: US 2009/0153875 A1
(43) Pub. Date: Jun. 18, 2009

(54) COORDINATE MEASURING MACHINE WITH TEMPERATURE ADAPTING STATION

(75) Inventor: Slawomir Czerkas, Weilburg (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Weilburg (DE)

(21) Appl. No.: 12/197,410

(22) Filed: Aug. 25, 2008

(30) Foreign Application Priority Data
Dec. 12, 2007 (DE) 10 2007 047 923.0

(51) Int. Cl. G01B 11/03; F28D 21/00

(52) U.S. Cl. 356/511; 165/104.33

(57) ABSTRACT

The invention relates to a coordinate measuring machine (1) and a method for adapting the temperature of substrates. The coordinate measuring machine (1) includes at least one measurement table (20) movable in the X-coordinate direction and in the Y-coordinate direction, a measurement objective (9) and a camera (10) for determining the positions of the structures (3) on the substrate (2). There is further provided an interferometer (24) for determining the positions of the measurement objective (9) and the measurement table (20). The entire system is enclosed by a housing (50) forming a climatic chamber, in which there are further provided a magazine (32) for substrates (2), a loading station (35) for substrates (2) and a transport means (38) transporting the substrates (2) between the loading station (35), the magazine (32) and/or the measurement table (20).

### RELATED APPLICATIONS

This application claims priority to German Patent Application No. 10 2007 047 923.0, filed on Dec. 12, 2007, which is incorporated herein by reference in its entirety.

### FIELD OF THE INVENTION

The present invention relates to a coordinate measuring machine comprising a tempering station having and a method for tempering of substrates while they are handled in a coordinate measuring machine comprising a tempering station.

### BACKGROUND OF THE INVENTION

A climatic chamber essentially serves to regulate temperature and humidity. Although the coordinate measuring machine and all other stations are normally accommodated in a climatic chamber, the substrates to be examined need to be brought to the temperature within the climatic chamber when they are transferred to the climatic chamber from outside. For this purpose, at least one of the further stations in the climatic chamber is implemented as a tempering station with which the substrates are brought to the temperature within the climatic chamber in a certain period of time.

A measuring device for measuring structures on wafers and/or masks is disclosed in the lecture script “Pattern Placement Metrology for Mask Making” by Dr. Carola Bläsing. The lecture was given on the occasion of the Semicon conference, Education Program, in Geneva on Mar. 31, 1998. A coordinate measuring machine is described in detail therein. It also mentions that the coordinate measuring machine is accommodated in a climatic chamber regulating the temperature <±0.01° C. and the humidity to <±1% of relative humidity. A laser interferometer is also disclosed, with which the position of the measurement table in the X/Y plane may be determined. A tempering station for the substrates is also provided in the climatic chamber.

German published application DE 199 49 005 discloses means and a method for introducing various transparent substrates into a high-precision measuring device. The system is accommodated in a climate-controlled chamber. Prior to the measurement, the temperature of the substrates to be measured should be brought to the temperature within the climate-controlled chamber.

Previous prior art systems needed a certain period of time for the temperature adaptation of the masks in the tempering station, which has a negative effect on the throughput of the machine. The substrates having a temperature of about 25° C. are transferred to the system and have to be brought to a temperature of 22° C. in the tempering station. This takes a certain amount of time until the substrate has reached the required temperature level. The mentioned difference in temperature is not to be considered as limiting the invention. It is obvious for someone skilled in that art that any differences in temperature may be adapted.

### SUMMARY OF THE INVENTION

It is the object of the present invention to provide a coordinate measuring machine comprising a tempering station integrated in a system for determining coordinates and structures on a substrate, wherein the tempering station is to be designed such that it allows a quick adaptation of the temperature of the substrate to the temperature within the climatic chamber.

This object is achieved by a coordinate measuring machine comprising: a tempering station, being located in a spatially defined area of the coordinate measuring machine; at least one measurement table movable in an X-coordinate direction and in an Y-coordinate direction; a measurement objective and a camera for determining the positions of the structures on the substrate; an interferometer for determining the positions of the measurement objective and the measurement table, wherein the coordinate measuring machine is enclosed by a housing forming a climatic chamber in which there are further provided a magazine for substrates; a loading station for substrates and a transport means transporting the substrates between the loading station, the magazine and/or the measurement.

It is further an object of the present invention to provide a method allowing a quick adaptation of the temperature of the substrate to the temperature within the climatic chamber.

This further object is achieved by a method for adapting the temperature of substrates while they are handled in a coordinate measuring machine comprising the steps of: providing a tempering station being enclosed by a housing forming a climatic chamber in which there are further provided a magazine for substrates, a loading station for substrates; transporting the substrates by a transport means between the loading station, the magazine and/or the measurement table; subjecting the substrates to the temperature adaptation in a spatially defined area of the coordinate measuring machine; and providing an increased air flow in the spatially defined area as compared to the other areas of the coordinate measuring machine enclosed by the housing.

It is advantageous and almost indispensable for the present invention that the system is enclosed by a housing representing a climatic chamber. The climatic chamber is provided with an active regulation for the temperature within the climatic chamber. According to the present invention, a coordinate measuring machine includes a tempering station, at least one measurement table movable in the X-coordinate direction and in the Y-coordinate direction, a measurement objective and a camera for determining the positions of the structures on the substrate. There is further provided an interferometer for determining the positions of the measurement objective and the measurement table. Furthermore, the system is enclosed by a housing forming a climatic chamber, in which there are further provided a magazine for substrates, a loading station for substrates, and a transport means transporting the substrates between the loading station, the magazine and/or the measurement table. According to the present invention, the tempering station is located in a spatially defined area of the coordinate measuring machine.

In this way, the tempering station forms a spatially defined and smaller unit within which it is easier to provide such conditions that a quick adaptation of the temperature of the substrate to the temperature within the climatic chamber is achieved.

According to one embodiment of the invention, the tempering station may be located in an area of the coordinate measuring machine that is essentially sealed off from other areas, which considerably facilitates achieving the predetermined measurement temperature.

Quick adaptation of the temperature and also of potential differences in air humidity introduced into the system from outside by the substrate may be ensured, for example, by having an increased air exchange take place at the tempering station in the separate or sealed off area of the system as compared to the other areas of the coordinate measuring machine enclosed by the housing. In that way, there may be an increased air flow in the separate or sealed off area as compared to the other areas of the coordinate measuring machine enclosed by the housing.

A particularly advantageous alternative of the invention provides air-directing plates being arranged between the tempering station and a ventilating means to influence the flow direction of the air directed to the tempering station. The air-directing plates provide the preferred supply of correspondingly climate-controlled air to the tempering station, so that temperature adaptation may be achieved more quickly with the help of these flow-influencing means.

The tempering station may be associated with the magazine or formed by the magazine. This ensures that the substrates to be examined are exposed to essentially constant ambient conditions. It may further be advantageous if the tempering station is designed such that the substrate and a depositing area are spaced only some μm apart, so that there is a large heat flow from the substrate to the tempering station.

A further advantageous embodiment is that, for temperature adaptation, the substrates may be brought into direct contact with the tempering station or with the storage compartments. In this way, the substrates may rest directly on depositing areas of the tempering station or may otherwise be kept in direct contact with the tempering station, which helps to quickly adapt or eliminate even very small differences in temperature. For this purpose, it may be very advantageous if the depositing areas of the tempering station each have a large heat capacity.

The present invention further includes a method for adapting the temperature of substrates while they are handled in a coordinate measuring machine comprising a tempering station and enclosed by a housing forming a climatic chamber in which there are further provided a magazine for substrates, a loading station for substrates and a transport means transporting the substrates between the loading station, the magazine and/or the measurement table, characterized in that the substrates are subjected to the temperature adaptation in a spatially defined area of the coordinate measuring machine separated from other areas. The substrates are subjected to the temperature adaptation in the tempering station, in an area of the coordinate measuring machine essentially sealed off from other areas.

Preferably, there is an increased air exchange in the separate or sealed off area of the tempering station as compared to the other areas of the coordinate measuring machine enclosed by the housing. This may be achieved, for example, by having an increased air flow in the separate or sealed off area of the tempering station as compared to the other areas of the coordinate measuring machine enclosed by the housing.

In particular, the substrates may be subjected to the temperature adaptation in the area of the magazine. In this case, the magazine is also the tempering station. It is advantageous if the substrates are brought into direct contact with the tempering station during their temperature adaptation. The substrates may rest directly on depositing areas of the tempering station, each of which has a large heat capacity.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 schematically shows a prior art coordinate measuring device;

FIG. 2 schematically shows a housing enclosing the system and designed as climatic chamber provided with a filter fan unit (FFU);

FIG. 3 shows a schematic view of the stations arranged inside the means; and

FIG. 4 shows a schematic arrangement of the air-directing elements generating an increased air flow by means of corresponding adjusting elements in the area of the tempering station so that an optimal air flow is achieved to attain quick temperature adaptation of the substrate.

### DETAILED DESCRIPTION OF THE PREFERRED EMBODIMENTS

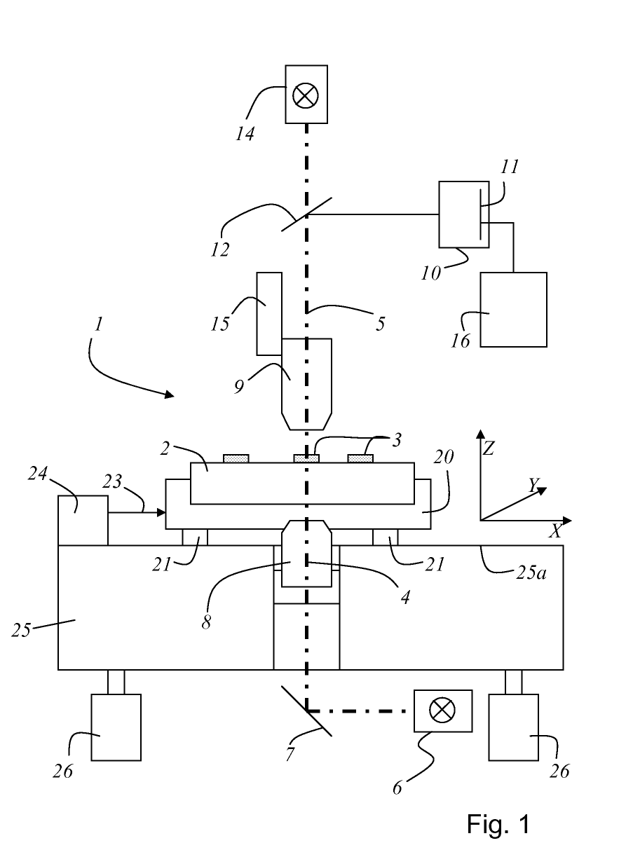

Several coordinate measuring devices 1 of the type shown in FIG. 1 are known from prior art. However, for the sake of completeness, the operation and arrangement of the individual elements of the coordinate measuring device 1 are described. The coordinate measuring device 1 includes a measurement table 20 arranged to be movable on air bearings 21 in the X-coordinate direction and in the Y-coordinate direction in a plane 25a. The plane 25a is formed of an element 25. In a preferred embodiment, the element 25 is a granite. However, it is clear to someone skilled in the art that the element 25 may also be formed of any other material guaranteeing an exact plane 25a for the translation of the measurement table 20. The position of the measurement table 20 is measured by at least one laser interferometer 24, which emits a light beam 23 for the measurement. The element itself is positioned on vibration dampers 26 to thus keep building vibrations away from the measuring device.

A substrate 2 carrying the structures 3 to be measured is deposited on the measurement table 20. The substrate 2 may be illuminated with a transmitted light illumination means 6 and/or an incident light illumination means 14. The light of the transmitted light illumination means 6 reaches the substrate 2 via a deflecting mirror 7 and a condenser 8. Similarly, the light of the incident light illumination means 14 reaches the substrate 2 via a measurement objective 9. The measurement objective 9 is provided with an adjusting means 15 allowing the adjustment of the measurement objective 9 in the Z-coordinate direction. The measurement objective 9 collects the light coming from the substrate 2 and directs it out of the incident light illumination axis 5 or the transmitted light illumination axis 4 by means of a semitransparent deflecting mirror 12 and directs it to a camera 10 provided with a detector 11. The detector 11 is connected to a computing system 16 generating digital images from the values measured by the detector 11.

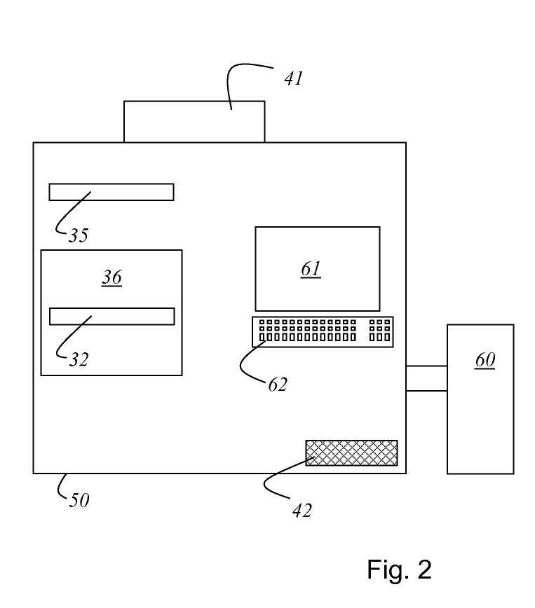

FIG. 2 shows a schematic representation, wherein there is provided a housing 50 enclosing at least the coordinate measuring machine 1. In a preferred embodiment, the housing 50 may be designed as a climatic chamber. The housing 50 is provided with a filter fan unit 41 blowing air into the interior of the housing 50. An air flow is thus generated inside the housing by this filter fan unit 41. In order to let out the air flow blown in by the filter fan unit 41, at least one outflow opening 42 is provided in the housing. The housing 50 also comprises a transfer station 35 via which the substrates 2 to be examined may be transferred to the housing 50, and a magazine 32. The housing 50 may further be provided with a display 61 having an input unit 62 (a keyboard in the present case) associated therewith. It is obvious for someone skilled in the art that the input unit 62 may be implemented in various ways. The input unit 62 may, for example, be a track ball, a joystick or a touch screen. Via this input unit 62, the user may supply input to the coordinate measuring machine 1 or to the further systems and means for controlling the measuring method for a substrate 2 in the housing 50. The housing is further connected to a control and electronic unit 60 responsible for controlling and evaluating the data acquired by the coordinate measuring machine 1. It is advantageous to arrange this control and monitoring means 60 outside the housing 50 so that there are a minimum of sources producing waste heat in the housing 50.

According to the present invention, a separate tempering station 36 is arranged in the housing 50, which is located in a spatially defined area of the coordinate measuring machine separated from the other areas of the housing's interior. In particular, the tempering station 36 may be arranged in an area of the housing 50 that is essentially sealed off from other areas. As can be seen from FIG. 2, the magazine 32 for the substrates is located in the tempering station 36. Preferably, the tempering station 36 is designed such that, for temperature adaptation, the substrates rest directly on depositing areas (not shown) of the tempering station 36 or may be brought into contact with these depositing areas or are at a distance of a few μm from the depositing areas.

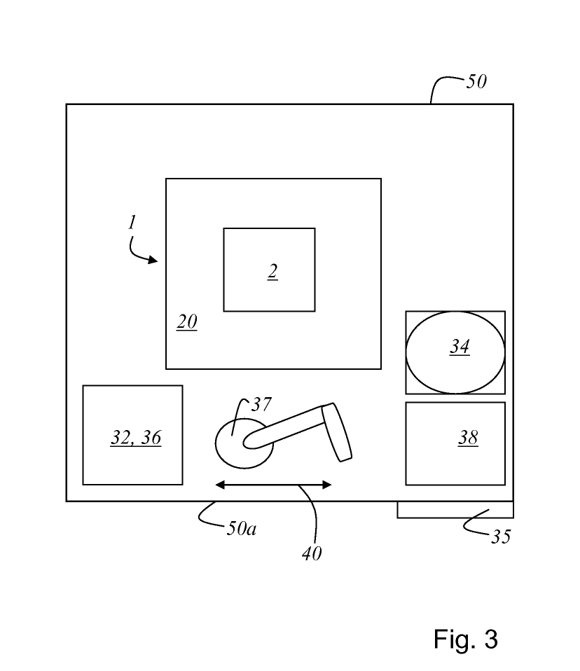

The schematic representation of FIG. 3 shows a further view of the arrangement of the coordinate measuring machine 1 and other means associated with the coordinate measuring machine 1 to thus guarantee an efficient examination and/or measurement of the substrates 2. FIG. 3 shows a simplified coordinate measuring machine 1. In FIG. 3, the coordinate measuring machine 1 is represented only by the measurement table 20 and the substrate 2 located on the measurement table 20. The coordinate measuring machine 1 and other means are together located in the housing 50 designed as a climatic chamber. In the embodiment shown, the magazine 32 for storing substrates 2 or masks within the climatic chamber is associated with the coordinate measuring means 1. The magazine 32 may be spatially associated with the tempering station 36 or may be formed integral therewith, as indicated in FIG. 3.

Means 34 for orienting the substrates 2 is also arranged in the climatic chamber. The transfer station 35 is provided in a wall 50a of the climatic chamber. A transport robot 37 and another transport means 38 may further be provided in the climatic chamber. In the climatic chamber, the robot 37 may move along the direction shown by the double arrow 40. The substrates 2 may be transferred to the climatic chamber and the magazine 32 via the transfer opening 35. The transport means 38 represents a transfer station. The robot 37 removes the substrate 2 from the transfer station 38 and, depending on the recipe, places it onto the means 35 for orienting, the measurement table 20 or into the magazine 32 within the tempering station 36.

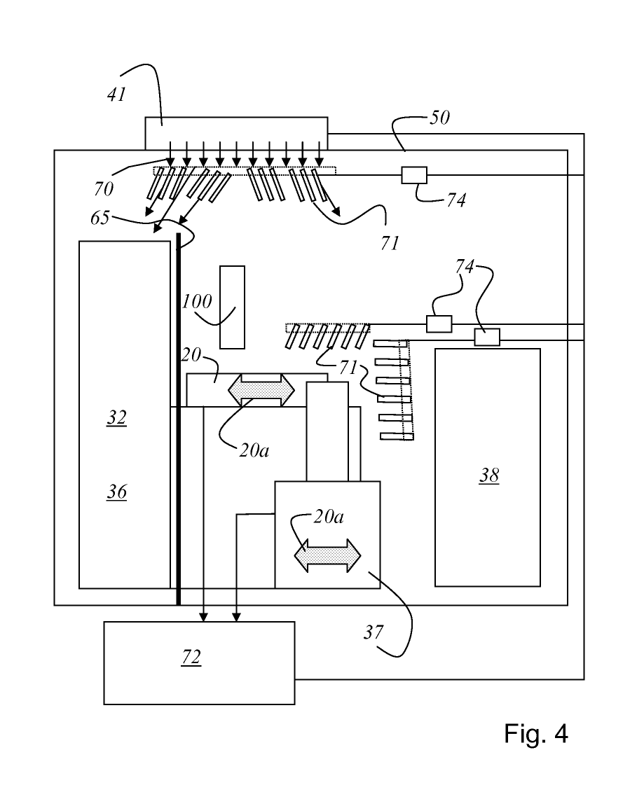

FIG. 4 shows a schematic embodiment of the means for measuring structures 3 on a substrate 2. As mentioned above, a plurality of stations 20, 32, 34, 35, 36, 37 and 38 are arranged inside the housing 50. In the embodiment shown, the measurement table 20 and the transport robot 37 are implemented as movable stations. The measurement table 20 is movable so that the structure to be examined on the substrate may be moved into the optical path of the optical measuring means 100. The transport robot 37 is also designed to be movable to transport the substrates to be examined to the various stations 20, 32, 34, 35, 36 and 38. The tempering station 36 and/or the magazine 32 are arranged in an area of the coordinate measuring machine (1) essentially sealed off from the other areas. In addition, several wall elements 65 may be provided in the climatic chamber for better sealing-off or separation. The movement of the movable stations 20 and 37 may cause a change in the air flow within the housing 50. The air flow 70 is blown into the housing by means of the filter fan unit 41. Several air-directing elements 71 are provided in the housing 50 and/or in the air flow 70. These air-directing elements 71 allow the air flow 70 to be directed correspondingly to each of the stations 20, 32, 34, 35, 36, 37 and 38. Furthermore, a preferred alternative of the present invention provides an increased air exchange in the area of the tempering station 36 as compared to the other areas to thereby achieve a quick temperature adaptation between the substrate 2 and the interior of the climatic chamber at any time.

In the embodiment shown in FIG. 4, the flow conditions are changed by means of the air-directing elements 71 such that desired flow conditions are created in the area of the tempering station 36. The position of the air-directing elements 71 may be stored in a database 72 as a function of the desired flow conditions in the area of the tempering station 36. If a quick temperature adaptation is desired, the air-directing elements 71 may be controlled such that there is a constant flow. In addition, the required larger amount of air for the tempering station 36 may thus be adjusted and varied. The air-directing elements 71 are controlled and/or changed by means of corresponding motors 74 associated with the air-directing elements 71.

For temperature adaptation, the substrate may be deposited in the at least one storage compartment (not shown) in the tempering station. There are several ways of depositing the substrate in the tempering station or in the storage compartment. One way is that both surfaces of the substrate 2 are free so that an air flow formed in the housing 50 flows around the substrate on both sides. The air-directing elements 71 in the housing may be adjusted such that this optimal flow is achieved. This allows a quick adaptation of the temperature. A further depositing possibility is that, in the tempering station, the distance between the substrate 2 and the depositing area is as small as possible, preferably some few μm, so that there is a large heat flow from the substrate 2 to the tempering station. The depositing areas of the tempering station 36 each have a large heat capacity.

While this invention has been particularly shown and described with references to preferred embodiments thereof, it will be understood by those skilled in the art that various changes in form and details may be made therein without departing from the scope of the invention encompassed by the appended claims.

What is claimed is:

1. A coordinate measuring machine comprising:
a tempering station, being located in a spatially defined area of the coordinate measuring machine;
at least one measurement table movable in an X-coordinate direction and in an Y-coordinate direction;
a measurement objective and a camera for determining the positions of the structures on the substrate;
an interferometer for determining the positions of the measurement objective and the measurement table,
wherein the coordinate measuring machine is enclosed by a housing forming a climatic chamber in which there are further provided a magazine for substrates;
a loading station for substrates and a transport means transporting the substrates between the loading station, the magazine and/or the measurement.

2. The coordinate measuring machine of claim 1, wherein the tempering station is located in an area of the coordinate measuring machine that is essentially sealed off from other areas.

3. The coordinate measuring machine of claim 2, wherein there is an increased air exchange in the separate or sealed off area of the tempering station as compared to the other areas of the coordinate measuring machine enclosed by the housing.

4. The coordinate measuring machine of claim 2, wherein there is an increased air flow in the separate or sealed off area as compared to the other areas of the coordinate measuring machine enclosed by the housing.

5. The coordinate measuring machine of claim 4, wherein air-directing plates are arranged between the tempering station and a ventilating means to influence the direction of the air flow directed to the tempering station.

6. The coordinate measuring machine of claim 1, wherein the tempering station is associated with the magazine or formed by the magazine.

7. The coordinate measuring machine of claim 1, wherein the substrate is deposited in the at least one storage compartment in the tempering station and an air flow in the housing is formed such that air flows around the substrate on both sides.

8. The coordinate measuring machine of claim 1, a distance between the substrate and a depositing area in the tempering station is as small as possible, preferably some few μm, so that there is a large heat flow from the substrate to the tempering station.

9. The coordinate measuring machine of claim 1, wherein the tempering station is designed such that the substrates may be brought into direct contact with the tempering station for temperature adaptation.

10. The coordinate measuring machine of claim 9, wherein the substrates rest directly on depositing areas of the tempering station.

11. The coordinate measuring machine of claim 10, wherein the depositing areas of the tempering station each have a large heat capacity.

12. A method for adapting the temperature of substrates while they are handled in a coordinate measuring machine comprising the steps of:
providing a tempering station being enclosed by a housing forming a climatic chamber in which there are further provided a magazine for substrates, a loading station for substrates;
transporting the substrates by a transport means between the loading station, the magazine and/or the measurement table;
subjecting the substrates to the temperature adaptation in a spatially defined area of the coordinate measuring machine; and
providing an increased air flow in the spatially defined area as compared to the other areas of the coordinate measuring machine enclosed by the housing.

13. The method of claims 12, wherein the substrates are subjected to the temperature adaptation in the area of the magazine.

14. The method of claim 12, wherein the substrate is deposited in the tempering station such that it has a distance of some few μm from a depositing area, so that there is a large heat flow from the substrate to the tempering station.

15. The method of claim 12, wherein the substrates are brought into direct contact with the tempering station during their temperature adaptation.

16. The method of claim 15, wherein the substrates rest directly on depositing areas of the tempering station, which each have a large heat capacity.
